(19) United States
(12) Patent Application Publication
(10) Pub. No.: US 2002/0169669 A1
(43) Pub. Date: Nov. 14, 2002

(54) Method and apparatus for serving a message in conjuction with an advertisement for display on a world wide web page

(76) Inventors: Samantha H. Stetson, Stamford, CT (US); Cara E. D'Amato, Peekskill, NY (US); Charles D. Wetmore, Darien, CT (US); Peter Lee, Sleepy Hollow, NY (US)

Correspondence Address: Buckley, Maschoff, Talwalkar & Allison LLC, 5 Elm Street, New Canaan, CT, 06840, US

(21) Appl. No.: 10/092,369

(22) Filed: Mar. 6, 2002

Related U.S. Application Data
(60) Provisional application No. 60/274,685, filed on Mar. 9, 2001.

(51) Int. Cl. G06F 17/60

(52) U.S. Cl. 705/14

(57) ABSTRACT

A method and apparatus for serving at least one message in conjunction with an advertisement for display on a World Wide Web page. The advertisement and message may be thematically related and displayed close to each other on the Web page. The advertisement and message may form all or part of a rich media file that is called when the Web page is served to a user device for display on the user device. The message maybe tailored to include information specific to a user viewing the Web page, message and advertisement to direct the user's attention to the advertisement or otherwise enhance the advertisement.

### CROSS-REFERENCE TO RELATED APPLICATION

This application is based on, and claims priority to, provisional patent application filed Mar. 9, 2001, having Application Serial No. 60/274,685 and entitled Method and Apparatus for Serving a Message in Conjunction with an Advertisement for Display on a World Wide Web Page, the contents of all of which are herein incorporated by reference for all purposes.

### FIELD OF THE INVENTION

This invention relates generally to a method and apparatus for displaying a message in conjunction with an advertisement on a World Wide Web page.

### BACKGROUND OF THE INVENTION

The World Wide Web (the “Web”) provides a breadth and depth of information to users. Typically, a user accesses portions of the information by visiting a World Wide Web site (“Web site”). For example, a user interested in learning more about the history and collection National Gallery of Art in Washington, D.C., USA, may visit its Web site (www.nga.gov). A user desiring to learn more about the products available at the Nordstroms department store may visit the company's Web site at www.nordstoms.com.

Companies and merchants typically develop and operate web sites to make their information about themselves and their goods and services more readily available to potential customers or other interested parties. Likewise, government institutions and agencies, universities, libraries, non-profit organizations, etc. also develop and operate Web sites to make information more easily available to the public.

An advertisement may be displayed on a Web page according to a number of different arrangements. For example, a Web site may display an advertisement on one of the Web pages for the Web site permanently. Alternatively, the Web site may rotate multiple advertisements on a given space on a Web page. The duration of each advertisement may be short (e.g., a few seconds) or long (e.g., as long as the Web page displayed). For a Web site that provides online searching capabilities, such as the portal at www.iwon.com operated by iWon, Inc., an advertisement shown to a visitor to the Web site may be based, at least in part, on search keywords provided or entered by the visitor. For example, a visitor entering the term “watch” as a keyword may be shown advertisements from one or more watch manufacturers.

Often, an advertisement on a Web site is a graphic image that runs on a Web page or is positioned in space on the Web page dedicated for advertisements. Such advertisements on a Web site may be or include animated GIF (Graphics Interchange Format) images, since animation often attracts a viewer's attention. Many conventional sizes for advertisements on Web pages have been developed and established by the Internet Advertising Bureau. For example, Web page advertisements commonly referred to as banners often have a size of 468×60 pixels. Web page advertisements commonly referred to as buttons often have a size of 420×60 pixels. Using conventional Web based advertising allows both advertisers and Web site operators and developers to efficiently develop and implement Web based advertising.

An advertisement also might include, or be included in, a rich media file. Rich media is commonly used to refer to Web or online based advertising technology that uses advanced features such as streaming video, applets, JAVA script, animated GIFs, etc.

Unfortunately, as viewers become more familiar and used to conventional advertising used with Web sites and Web pages, the effectiveness of such advertising may become reduced, even if such advertising is targeted based on search keywords. Thus, despite the state-of-the-art in Web based advertising, there remains a need for a method and apparatus for providing advertising on Web pages that increases viewer response rates and the effectiveness of the advertising.

### SUMMARY OF THE INVENTION

Accordingly, it is an object of the present invention to provide a method and apparatus for increasing viewer response rates to advertising displayed on a Web page by providing a message in conjunction with one or more advertisements displayed on the Web page. In some embodiments, the message may be personalized or otherwise tailored to a user viewing the Web page. In addition, the message may be thematically related to the advertisement and/or positioned proximal to the advertisement on the Web page when the Web page is displayed.

Additional objects, advantages, and novel features of the invention shall be set forth in part in the description that follows, and in part will become apparent to those skilled in the art upon examination of the following or may be learned by the practice of the invention. The objects and the advantages may be realized and attained by means of the instrumentalities and in combinations particularly pointed out in the appended claims.

To achieve the foregoing and other objects and in accordance with the purposes of the present invention, as embodied and broadly described herein, a method for serving an advertisement includes determining an advertisement to be displayed on a Web page; determining a message to be displayed on the Web page, wherein the message is associated with the advertisement; receiving a request to serve the Web page; serving the Web page; serving the advertisement for display on the Web page; and serving the message for display on the Web page.

In some embodiments, the method may also include tailoring the message page based, at least in part, on personal information; and/or causing said message or tailored message to be displayed proximal to the advertisement on the Web page. The method may also include determining personal information for use in tailoring the message; determining targeting criteria for use in determining if or how the message might be displayed or tailored; and/or determining if targeting criteria for a message has been met or completed. In some embodiments, the message maybe associated with the advertisement or thematically related to the advertisement. The message and the advertisement may form, in some embodiments, all or part of a rich media file. In some embodiments, more than one message may be determined and/or associated with an advertisement. In such embodiments, the method also may include selecting which of the messages to display on the Web page and serving the selected message for display on the Web page.

Also to achieve the foregoing and other objects and in accordance with the purposes of the present invention, as embodied and broadly described herein, an apparatus or system for performing some or all of the method described above. In some embodiments, such an apparatus or system may include a memory; a communication port; and a processor connected to the memory and the communication port, the processor being operative to: determine an advertisement to be displayed on a Web page; determine a message to be displayed on said Web page, wherein the message is associated with the advertisement; receive a request to serve the Web page; serve the Web page; serve the advertisement for display on said Web page; determine personal information; tailor the message page based, at least in part, on the personal information; and serve the tailored message for display on the Web page. The processor may also be operative to perform one or more of the components of the method described above. The message also may be thematically related to the advertisement. In another embodiment, a system for displaying an advertisement and a message on a Web page includes a memory; a communication port; and a processor connected to the memory and the communication port, the processor being operative to determine an advertisement to be displayed on a Web page; determine a tailorable message to be displayed on the Web page; prepare a rich media file that contains the advertisement, the message, and code governing how the message is to be tailored when the message is displayed on the Web page, wherein the Web page includes an ad tag directed to the rich media file; and serve the Web page in response to a request for the Web page.

In another embodiment of an apparatus or system in accordance with the present invention, an apparatus or system for serving an advertisement may include means for establishing an advertisement to be displayed on a Web page; means for establishing a message to be displayed on the Web page, wherein the message is associated with the advertisement; means for obtaining a request to serve the Web page; means for transmitting the Web page; means for transmitting the advertisement for display on the Web page; means for retrieving personal information; means for customizing the message page based, at least in part, on the personal information; and means for transmitting the customized message for display on the Web page. The apparatus or system may also include means for performing some or all of the components of the method described above. The message also may be thematically related to the advertisement. In another embodiment, an apparatus for displaying an advertisement and message on a Web page may include means for establishing an advertisement to be displayed on a Web page; means for establishing a tailorable message to be displayed on the Web page; means for creating a rich media file that contains the advertisement, the message, and code governing how the message is to be tailored when the message is displayed on the Web page, wherein the Web page includes an ad tag directed to the rich media file; and means for transmitting the Web page in response to a request for the World Wide Web page.

Also to achieve the foregoing and other objects and in accordance with the purposes of the present invention, as embodied and broadly described herein, a method for displaying a message in conjunction with an advertisement on a Web page, wherein the advertisement and the Web page have been served, includes determining targeting criteria associated with the advertisement; determining personal information; tailoring a message based on the personal information and the targeting criteria; and serving the tailored message for display on the Web page. The method may also include causing the message to be displayed in proximity to the advertisement on the Web page. In some embodiments, the message may be thematically related to the advertisement.

Also to achieve the foregoing and other objects and in accordance with the purposes of the present invention, as embodied and broadly described herein, a computer readable medium may comprise a rich media file that includes an advertisement to be displayed on a Web page and a tailorable message to be displayed on the Web page, wherein the rich media file is callable via an ad tag associated with the Web page. In another embodiment, a computer readable medium includes code for a Web page, wherein the code includes an ad tag that causes a call for a rich media file when the Web page is displayed on a user device, the rich media file including an advertisement to be displayed on the Web page and a tailorable message to be displayed on the Web page. In another embodiment, a computer readable medium for use in a server hosting a Web site may include computer readable means for establishing an advertisement to be displayed on a Web page; computer readable means for establishing a message to be displayed on the Web page, wherein said message is associated with the advertisement; computer readable means for obtaining a request to serve the Web page; computer readable means for transmitting the Web page; computer readable means for transmitting the advertisement for display on the Web page; computer readable means for retrieving personal information; computer readable means for customizing the message page based, at least in part, on the personal information; and computer readable means for transmitting the customized message for display on the Web page. In another embodiment, a computer readable medium may include computer readable means for establishing an advertisement to be displayed on a Web page; computer readable means for establishing a tailorable message to be displayed on the Web page; computer readable means for creating a rich media file that contains the advertisement, the message, and code governing how said message is to be tailored when the message is displayed on the Web page, wherein the Web page includes an ad tag directed to the rich media file; and computer readable means for transmitting the Web page in response to a request for the Web page.

Also to achieve the foregoing and other objects and in accordance with the purposes of the present invention, as embodied and broadly described herein, a portion of computer software comprising a rich media file may includes an advertisement to be displayed on a Web page, a tailorable message to be displayed on the Web page, and code for controlling how the message is be tailored, wherein the rich media filed is callable via an ad tag associated with HTML code for the Web page. In another embodiment, a portion of computer software includes code for a Web page, wherein the code includes an ad tag that causes a call for a rich media file when the Web page is displayed on a user device, the rich media file including an advertisement to be displayed on the Web page, a tailorable message to be displayed on the Web page, and code controlling how the message is to be tailored.

Also to achieve the foregoing and other objects and in accordance with the purposes of the present invention, as embodied and broadly described herein, a method for displaying an advertisement and a message on a Web page includes determining an advertisement to be displayed on a Web page; determining a tailorable message to be displayed on the Web page; preparing a rich media file that contains the advertisement, the message, and code governing how the message is to be tailored when the message is displayed on the Web page, wherein the Web page includes an ad tag directed to the rich media file; and serving the Web page in response to a request for the Web page.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

In the Drawings:

FIG. 1 is a flowchart of a first embodiment of a method in accordance with the present invention;

FIG. 2 is an illustration of a representative Web page displaying a banner advertisement that may be used with the method of FIG. 1;

FIG. 3 is an illustration of the Web page of FIG. 2 with a tailored message positioned proximal to an advertisement on the Web page;

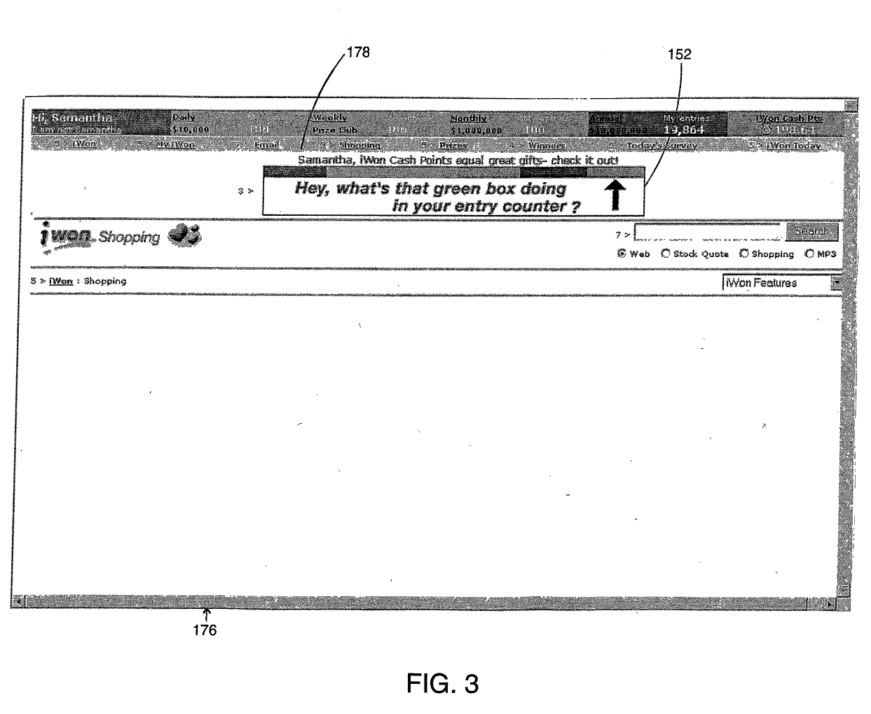

FIG. 4 is another illustration of the Web page of FIG. 2 with a tailored message positioned proximal to an advertisement on the Web page;

FIG. 5 is an illustration of a representative Web page displaying and advertisement and a message in accordance with the method of FIG. 1;

FIG. 6 is a block diagram of system components for an embodiment of an apparatus usable with the method of FIG. 1;

FIG. 7 is a flowchart of a second embodiment of a method in accordance with the present invention;

FIG. 8 is a flowchart of a third embodiment of a method in accordance with the present invention;

FIG. 9 is a flowchart of a fourth embodiment of a method in accordance with the present invention;

FIG. 10 is a flowchart of a fifth embodiment of a method in accordance with the present invention;

FIG. 11 is a flowchart of a sixth embodiment of a method in accordance with the present invention;

FIG. 12 is a block diagram illustrating a representative Web site server of FIG. 6; and

FIG. 13 is a block diagram illustrating a representative user device of FIG. 6.

### DETAILED DESCRIPTION OF THE EMBODIMENTS

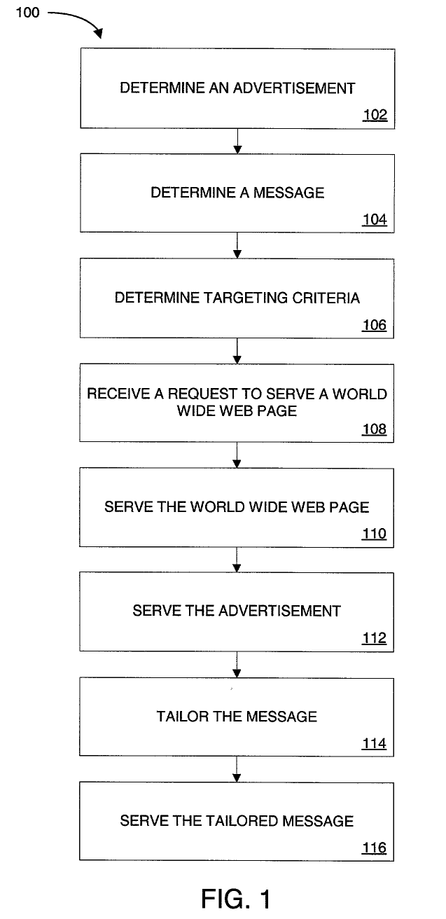

A first embodiment 100 of a method in accordance with the principles of the present invention is illustrated in FIG. 1. The method 100 allows a server or other device that serves or otherwise downloads a Web page to also serve, or cause to be served, an advertisement and a message for display on the Web page. The message maybe thematically related to the advertisement or displayed in proximity to the advertisement so that the message helps direct a user's attention to the advertisement or otherwise enhances the advertisement. In some embodiments, the message may be tailored such that the message is customized for a specific user or specific external event.

In general, a Web page may have many elements associated with it, such as advertisements, test messages, logos, images, etc. The layout and design of some or all of the Web page may be governed by coding the Web page using the Hypertext Markup Language (HTML). Thus, a Web page may have one or more designated areas in which an advertisement such as a banner, is to be displayed. The actual advertisement displayed on a Web page may change for different users.

The method 100 illustrated in FIG. 1 includes a step 102 during which an advertisement to be displayed on a Web page is determined. In some embodiments, an advertiser may provide an advertisement that is to be displayed on a Web page. In other embodiments, an ad server may determine which advertisement is to be displayed on the Web page.

The method 100 also includes a step 104 during which a message to be displayed on the Web page is determined. For example, the advertiser who selects or otherwise provides the advertisement determined during the step 102 may provide the message that is to be displayed in conjunction with the advertisement. The message determined during the step 104 and the advertisement determined during the step 102 may form all or part of a rich media file that is called or retrieved when the Web page is served, as will be discussed in more detail below. Typically such a call or retrieval may be made by browser software operating on a user device, the call or retrieval being made when the Web page is served to the user device for display on the user device. The Web page may include coding that instructs the browser software how to make the call or retrieval.

During a step 106, targeting criteria is determined that enables a server serving the advertisement to determine if the message should also be displayed and/or how the message should be displayed. For example, targeting criteria may limit a certain advertisement and/or message to being displayed to a user only when the user is male, under the age of thirty, etc. The advertiser who supplies the advertisement and or the message may also supply the targeting criteria.

During a step 108, a request to serve a Web page is received. The request may come from a user device, such as a computer, a proxy server, or some other device. Typically, such a request will be generated by browser software operating on a user device such as a computer. During a step 110, the requested Web page is served or otherwise provided. The advertisement determined during the step 102 is served during a step 112. During a step 114, the message determined during the step 104 is tailored in accordance with the targeting criteria. For example, a message may be tailored for a particular user by including the user's first name in the message (e.g., “Greetings Samantha, We Think You'll Like This Offer”). During a step 116, the tailored message is served for display with the Web page along with the advertisement on a user device or other device. As previously discussed above, the advertisement served during the step 112 and the message served during the step 116 may form all or part of the same rich media file that is called as part of a Web page being displayed on a user device. Thus, the advertisement and the message may be served at the same time or as part of the same rich media file.

For purposes of the present invention, the term “advertisement” should be construed broadly to include any of the conventional Web based creatives used in online advertising, such as a banner, button, badge, clickbox, etc. In addition, an “advertisement” may also include other forms, formats, implementations or sizes of creatives or materials used in online advertising.

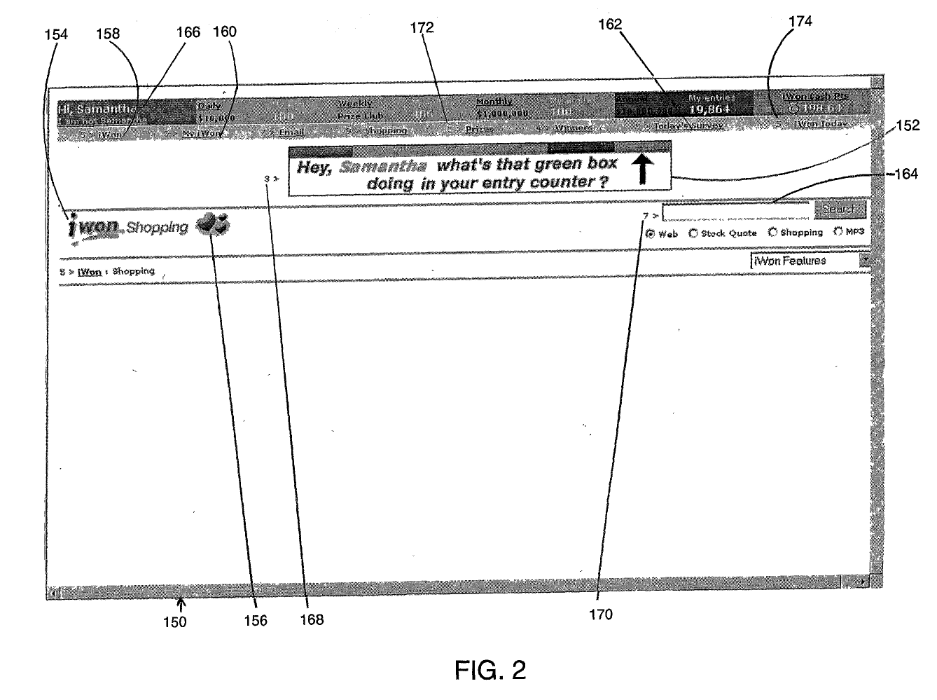

A portion of a Web page 150 displaying a conventional banner advertisement 152 is illustrated in FIG. 2. The advertisement 152 has a conventional banner size of 468 pixels by 60 pixels. The Web page 150 also includes other images and logos 154,156, links 158,160,162, and a search field 164. The Web page 150 has been customized or personalized for a user named “Samantha”, as indicated by the text message 166.

Customization of a Web page may be done by the use of “cookies” stored on a user's computer. In general, a “cookie” is a small file of information that a Web site stores on a user's computer so that the Web site can retrieve and use the information at a later time when the user visits the Web site again. For example, a cookie may store information regarding a user's name or preferences when the user is visiting a particular Web site. Thus, using a cookie provides a way for a Web site to store its own information about a user on the user's own computer. Cookies may be used to customize Web pages for a particular user based on information the user has previously provided to the Web site serving the Web pages. Cookies may also allow a Web site to keep track of how often users are using specific areas of the Web site or simply visiting the Web site each month. In some cases, a cookie may be used to store a user identification number or code associated with a specific user, which can be used to access and retrieve additional information from a database.

The Web page 150 also includes several examples 168, 170, 172, 174 of use of the Alt Text feature to display text information on the Web page 150. The Alt Text feature allows text, but not code, to be associated with images or other objects that are to be displayed on a Web page. In some cases, the text material associated with an object on the Web page may not be displayed unless a user moves a cursor over or next to the object. In other cases, the text material may be continuously displayed on the Web page. The Alt Text feature allows only text information to be displayed on a Web page and the Alt Text information forms part of the HTML coding for the Web page. Thus, the Alt Text information is viewable when the source code for the HTML coding for the Web page is viewed.

As an example of how the method 100 might serve a Web page having an advertisement and message, a Web page 176 includes the same banner advertisement 152 and other features and elements of the Web page 150. In addition, the Web page 176 includes a message 178 positioned and displayed above, and in proximity to, the advertisement 152. The message 178 is tailored to a user named “Samantha” and helps direct the user's attention to the advertisement 152, thereby increasing the chances that the user will view the advertisement 152 and perhaps click on the advertisement 152.

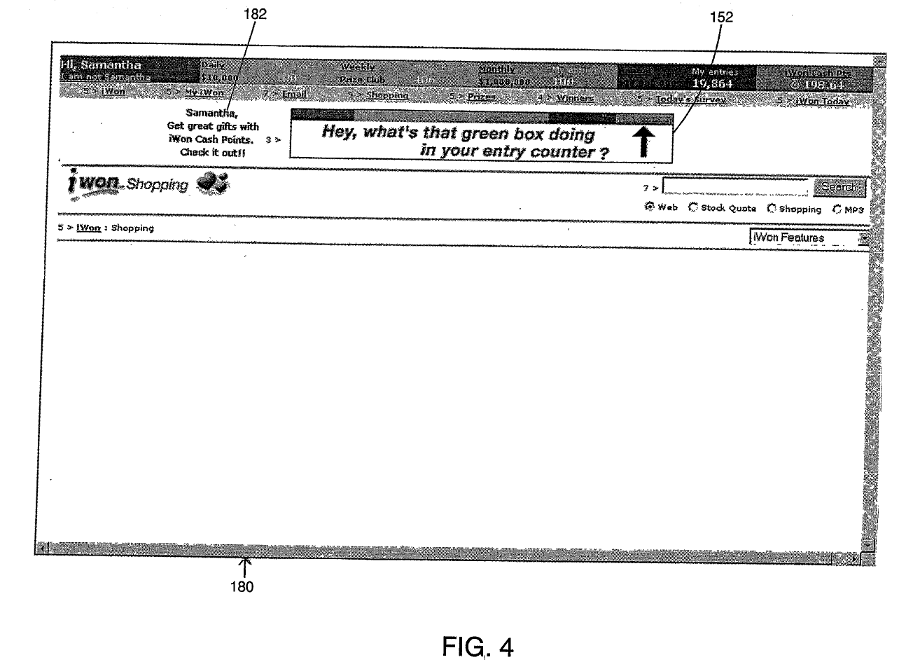

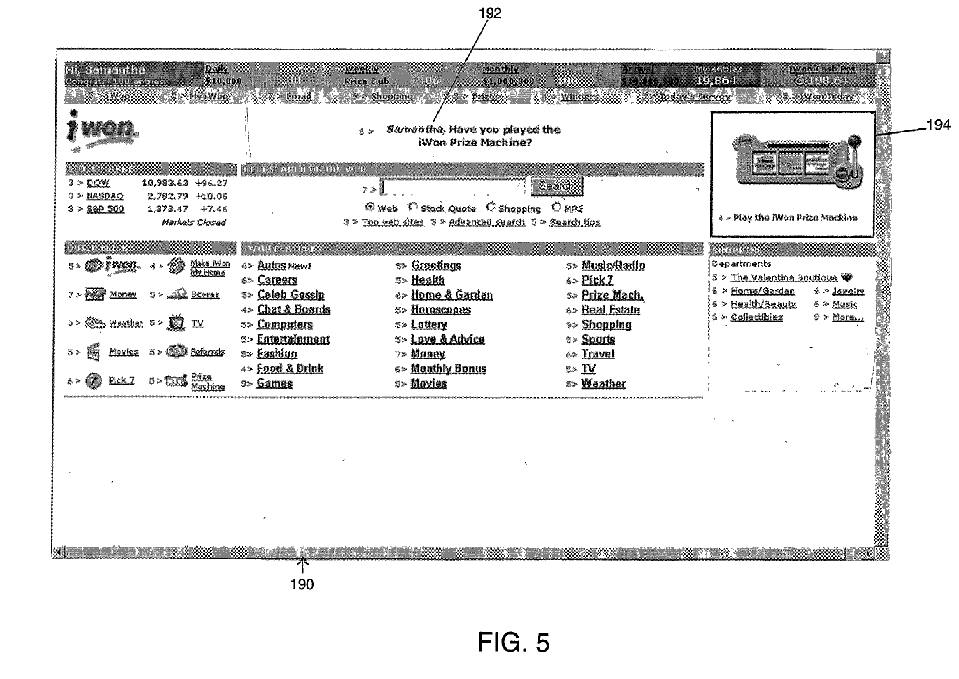

In some embodiments, a message maybe displayed on the side of an advertisement on a Web page, as illustrated by a Web page 180, advertisement, 152, and message 182 illustrated in FIG. 4. In other embodiments, a message may be displayed instead of the conventional banner advertisement 152 on a Web page to direct attention to another advertisement on the Web page, as illustrated by a Web page 190, message 192 and advertisement 194 in FIG. 5. As illustrated by the message 192 and the advertisement 194, the subject matter of the message may be related to the subject matter of the advertisement, thereby creating a common or related theme between the message and the advertisement.

The method and apparatus of the present invention allow a message to be displayed in such a way to direct attention to an advertisement on a Web page, thereby increasing the success of the advertisement an the response rate of users who view the advertisement. The message may be positioned or displayed close or otherwise proximal to the advertisement. In addition, the message may be tailored to increase its impact and ability to direct attention to the advertisement. The message also may be thematically related to the advertisement. These and other advantages of the method and apparatus of the present invention will be discussed in more detail below. In addition, the method 100 and each of the steps 102, 104, 106, 108, 110, 112, 114 and 116 will be discussed in more detail below.

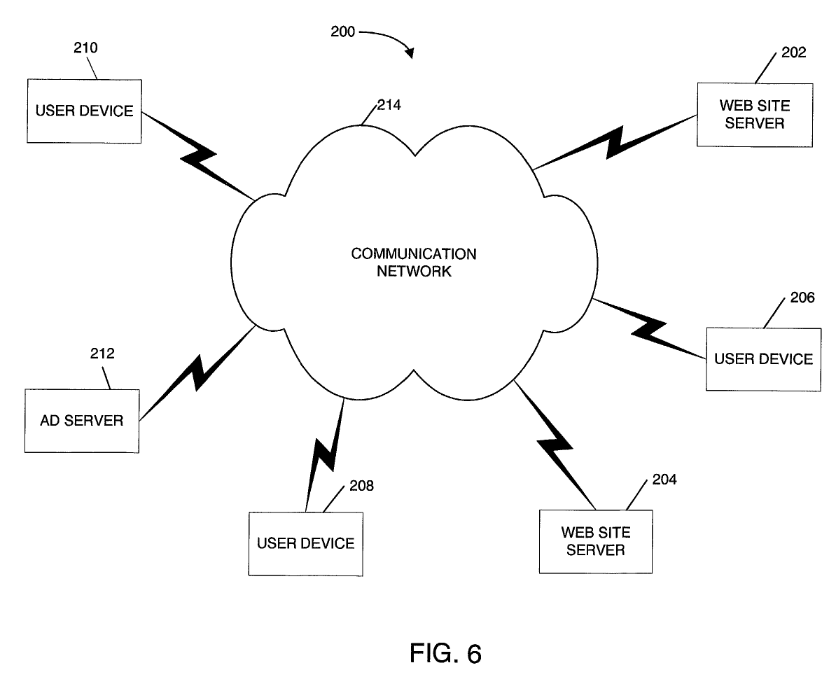

Now referring to FIG. 6, an apparatus or system 200 usable with the method 100 is illustrated. The apparatus 200 includes one or more Web site servers or controllers 202, 204 that may communicate directly or indirectly with one or more user or client devices 206, 208, 210, and/or one or more ad servers 212 via a computer, data, or communications network 214. For purposes of further explanation and elaboration of the method 100 and the other methods described below, the method 100 will be assumed to be operating on, or under the control of, the Web site server 202.

The server 202 preferably performs the steps 102, 104, 106, 108, 110, 112, 114 and 116 of the method 100. The server 202 may process or receive requests for Web pages from/for users who may be using the user devices 206, 208, 210. The server 202 may implement or host a Web site that users can access via the communications network 214. For example, the server 202 may be the server implementing or hosting the Web site found at www.iwon.com. A server can comprise a single device or computer, a networked set or group of devices or computers, a workstation, etc. In some embodiments, a Web site server may also function as or include an ad server, a database server, and/or user device. The use, configuration and operation of server devices will be discussed in more detail below.

The user or client devices 206, 208, 210 preferably allow users to interact and communicate with the server 202 and the remainder of the apparatus 200. The user devices 206, 208, 210 may also enable a user to access Web sites hosted or operated by the servers 202 and 204. If desired, the user devices 206, 208, 210 may also be connected to or otherwise in communication with other devices. Possible user devices include a personal computer, portable or laptop computer, mobile or fixed user station, workstation, network terminal or server, cellular telephone, kiosk, dumb terminal, personal digital assistant, client device, etc. The use, configuration and operation of user devices will be discussed in more detail below.

The ad server 212 may be used to store advertisements that are displayed on or with a Web site. The use and operation of ad servers are known to people of skill in this art and further discussion of ad servers is not required for purposes of elaboration and explanation of the present invention. Further information on online advertising and the use of ad servers can be found in Jim Sterne, Advertising on the Web, 1997; Robin Lee Zeff and Bradley Aronson, Advertising on the Internet, 2^{nd} Edition, 1999; and Paul J. Dowling et al., Web Advertising and Marketing, 1998, the contents of all of which are incorporated herein by reference. Additional information regarding online advertising and ad servers can be found in U.S. Pat. No. 6,161,127 issued to Cezar et al., U.S. Pat. No. 5,959,623 issued to van Hoffet al., U.S. Pat. No. 5,948,061 issued to Merriman et al., U.S. Pat. No. 5,937,392 issued to Alberts, and U.S. Pat. No. 5,933,811 issued to Angles et al., the contents of all of which are incorporated herein by reference.

Many different types of implementations or hardware configurations can be used in the system 200 and the methods disclosed herein are not limited to any specific hardware configuration of or operation of the system 200 or any of its components.

The communications network 214 might be or include the Internet, the World Wide Web, or some other public or private computer, cable, telephone, data or communications network or intranet.

The communications network 214 illustrated in FIG. 2 is only meant to be generally representative of cable, computer, telephone, data or other communication networks for purposes of elaboration and explanation of the present invention and other devices, networks, etc. may be connected to the communications network 214 without departing from the scope of the present invention. The communications network 214 can also include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a Web site server without departing from the scope of the present invention.

Now referring again to FIG. 1, the method 100 and the steps 102,104, 106,108, 110,112, 114 and 116 will be discussed in more detail in relation to the system 200 illustrated in FIG. 6. For purposes of elaboration, but not limitation, of this discussion, the server 202 will be assumed to be implementing the method 100. As previously discussed, a Web page, such as the Web page 150 illustrated in FIG. 2, may have many elements associated with it and the arrangement is usually determined in advance by HTML or other coding of the Web page. Thus, a Web page may have one or more designated areas in which an advertisement, such as a banner, is to be displayed. However, the actual advertisement displayed on a Web page may change for different users.

As previously discussed above, the method 100 includes a step 102 during which an advertisement to be displayed on a Web page is determined by the server 202. Such determination during the step 102 may occur in a variety of ways. For example, the server 202 may receive from another device or entity an actual copy of the advertisement to be displayed on the Web page. The advertisement and/or Web page maybe coded or otherwise prepared such that the advertisement is displayed on the Web page every time the Web page is displayed. Alternatively, a link to an advertisement, or a rich media file that includes the advertisement, may be included in the Web page as part of the coding of the Web page instead of the actual advertisement itself. Thus, the advertisement, or rich media file including the advertisement, is determined by including the proper link in the coding of the Web page. When the server 202 serves the Web page, a call or request is automatically made using the link by the server 202, or a user device receiving the Web page, to an ad server or other device on which the advertisement, or the rich media file that includes the advertisement, is stored. The advertisement is retrieved from the ad server and displayed on the user device in its designated position on the Web page. The advertisement may be received from an advertiser, advertising agency, etc.

The step 102 may be completed by placing a Web page and an advertisement on the server 202, or one or more links to the Web page and the advertisement on the server 202, such that the server 202 can serve or process a request for the Web page when such a request is received during the step 108. The step 102 may also be completed when an advertisement is received by the server 202 or by any entity controlling or operating the server 202 for use with the Web page.

The step 102 may occur in advance of a Web page request being received by the server 202 or after the request for the Web page is received by the server 202. Thus, the step 108 may occur before the step 102 in some embodiments or implementations of the method 100.

During the step 104, a message is determined that will be displayed in conjunction with the advertisement determined during the step 102. Thus, the message determined during the step 104 is associated with the advertisement determined during the step 102. In general, such association may cause the message, or a tailored version of it, to be displayed on a Web page whenever the advertisement is displayed on the Web page. In some embodiments, a group or plurality of messages may be associated with an advertisement such that at least one of the messages is displayed on a Web page when the advertisement is displayed on the Web page. In other embodiments, a group or plurality of messages may be associated with an advertisement such that at least one of the messages is displayed on a Web page when the advertisement is displayed on the Web page and targeting criteria or other conditions are met.

Messages may include text portions such as, for example, “Happy Birthday”, “Take a Look at This!”, “Get Great Credit Card Rates by Signing Up Now”, “Buy One Get One Free”, etc. In some embodiments of the present invention, a message may be tailored for or to a specific user by including user information into the message. For example, messages may include text portions such as “Happy Birthday Samantha”, “Hey Samantha, Take a Look at This!”, “Buy One Samantha and You Get Another One Free”, “Check Out This Great Deal On Hotel Reservations Samantha!”, etc. for a user named “Samantha”.

The ability to personalize or otherwise tailor a message for a user requires that the server 202 have access to personal information regarding the user. Such user information may be stored in a cookie on the user's user device or in a database. The user information may be collected or retrieved by the server 202 or another device or entity for use in tailoring messages or advertisements. The user information may be stored, updated, maintained, retrieved, accessed, etc. by the server 202 or another device.

The ability to tailor or personalize a message for a user may also require that the message be encoded, formatted or otherwise designed in a way to indicate to the server 202, an ad server, or another device that user information is to be inserted into the message prior to sending or transmitting the message to a user device or other device. For example, the message may be encoded or formatted as “Happy Birthday <fname>!” where the portion “<fname>” indicates that the sever 202 is to retrieve a user's first name from, for example, a stored cookie or a user information database and insert the user's first name into the message when serving the tailored message and/or displaying the tailored message on the Web page.

The determination made during the step 104 may be done or completed in a variety of ways. For example, the server 202 may receive an actual copy of the message to be displayed on the Web page. The advertisement and/or Web page may be coded or otherwise prepared such that the message is displayed on the Web page every time the Web page is displayed and/or every time the advertisement is served or displayed on the Web page. Alternatively, a link to the message, or a rich media file that includes the message, may be included or coded in the Web page instead of the actual message itself. Thus, the message is determined by including the proper link in the coding of the Web page. When the server 202 serves the Web page, a call or request is automatically made using the link by the server 202, or a user device receiving the Web page, to an ad server or other device on which the message, or the rich media file that includes the message, is stored. The message is retrieved and displayed on the user device in its designated position on the Web page. The message may be received from an advertiser, advertising agency, etc. and may be received or determined in conjunction with an advertisement. In some embodiments, a message and a advertisement may form part of one same rich media file and a single link may be coded in the Web page for calling or retrieving the rich media file and, as a result, calling or retrieving the message and the advertisement.

The step 104 may be completed by placing a Web page and a message on the server 202, or one or more links to the Web page and the message on the server 202, such that the server 202 can serve or process a request for the Web page when such a request is received during the step 108. The step 104 may also be completed when an message is received by the server 202 or by any entity controlling or operating the server 202.

The step 104 may occur in advance of a Web page request being received by the server 202 or after the request for the Web page is received by the server 202. Thus, the step 108 may occur before the step 104 in some embodiments or implementations of the method 100. The step 104 may also occur before the step 102 or in conjunction with the step 102.

During the optional step 106, targeting criteria may be determined for use with the message determined during the step 104. For example, targeting criteria may provide that the message determined during the step 104 is to be displayed to a user only when the user is male, under thirty years of age, living on the east coast, etc. As another example, targeting criteria may provide that the message determined during the step 104 is to be displayed to a user only when the user's first name is known, only on Saturdays, only on the user's birthday, only when the message can be tailored, etc.

The step 106 may occur in advance of a Web page request being received by the server 202 or after the request for the Web page is received by the server 202. Thus, the step 108 may occur 5 before the step 106 in some embodiments or implementations of the method 100. The step 106 may also occur before either of the steps 102 and 104.

During the step 108, a request is received to serve a Web page. Typically, such a request will come directly or indirectly from a user device, such as the user device 206. In some embodiments, the request will be generated by browser software operating on a user device when a user enters a Universal Resource Locator (URL), such as www.iwon.com, associated with the Web desired web page. The request provides information to the server 202 regarding the desired Web page and where to send the desired Web page. Additional information regarding the operation and use of requests for Web pages can be found in U.S. Pat. No. 5,737,619 issued to Judson, the contents of which is incorporated herein by reference. Further information regarding a request/response conversation or interaction between devices can be found in Nancy J. Yeager and Robert E. McGrath, Web Server Technology (1996), the contents of which is incorporated herein by reference. As previously discussed above, the step 108 may occur before any of the steps 102, 104, and/or 106.

During the step 110, the server 202 provides or otherwise serves the requested Web page directly or indirectly to the device from which the request was received during the step 108. For example, the server 202 may serve a Web page to the user device 206 such that the user device 206 can display the Web page using browser software operating on the user device 206. As previously discussed above, the Web page preferably has an advertisement and a message associated with it. While the step 110 occurs after the step 108, the step 110 may occur before any of the steps 102, 104, and/or 106. The coding for the Web page will govern how and where the advertisement and message are displayed on the Web page.

During the step 112, the advertisement determined during the step 102 is served for display on the Web page served during the step 110. The step 112 may occur simultaneously with, or as part of, the step 110. The advertisement served during the step 112 may be associated with code or instructions that cause the message to be served during the step 114. For example, if the advertisement is part of a rich media file, the rich media file may contain code (e.g., JAVA script) that causes the message to be served during the step 114. The message itself maybe part of the rich media file along with the advertisement.

Embedding or including code to display or serve the message in the rich media file along with the advertisement has many advantages. First, such a process enables code to retrieve or serve the message to be left out of the HTML code used to build and operate the Web page that the advertisement and message will be displayed on. Thus, the code for the message is not viewable to anyone who views the source code of the HTML created Web page. Second, such a process enables sophisticated control of the message to be created and displayed. For example, the message may blink, change blink rate, change colors, change it's text, change font, disappear after a designated period of time, appear on the Web page only after a designated period of time after the Web page is displayed, etc.

For purposes of the method 100 and other methods disclosed herein, the step 112 will be considered satisfied and implemented if the Web page served during the step 110 includes an ad tag (also referred to as an “ad call” or “ad request”) or other instruction included in it, perhaps as part of the Web page's HTML code, that causes a request for the advertisement, or a rich media file including the advertisement, to be sent from a device (e.g., a user device) that is displaying the Web page when the Web page is displayed or process by the device. The request may be sent to a device other than the device that served the Web page during the step 110 (e.g., a device other than the server 202). Thus, the step 112 may be completed by coding the Web page served during the step 110 such that the advertisement is served or otherwise sent (perhaps as part of a rich media file) from a device other than the server 202 or other than the device that served the Web page during the step 110. As a result, “serving the advertisement” includes, and is completed by, directing a recipient device of the Web page served during the step 110 to where the recipient device can send a request for the advertisement or a rich media file containing the advertisement. Such directing of the recipient device can be completed by including an ad tag or appropriate instruction in the HTML code for the Web page served during the step 110.

During the step 114, the message determined during the step 104 is tailored for a particular user. Tailoring of a message during the step 114 may use user information or other information provided in the request received during the step 108. For example, a message may be tailored to include a user's name, city of residence, birthday, or other personal information. Alternatively, tailoring the message 104 during the step 114 may require the server 202 to retrieve user information from a cookie stored on a user device or from a user information database. For example, the server 202 may need to determine the first name of a user as part of tailoring a message for the user. The message may be tailored to include the user's first name in the message.

Tailoring of a message during the step 114 may also require use of the targeting criteria determined during the step 106. For example, targeting criteria may provide that the message determined during the step 104 is to be displayed to a user only on the user's birthday. Thus, the server 202 may need to retrieve birthday information regarding the user from a user database or stored cookie to determine if the message is to be displayed to the user. In another example, the targeting criteria may provide that the message is to be displayed to a user only if the user is a female. The message may be tailored during the step 114 to include a user's first name.

Assuming that the targeting criteria does not prevent a message from being displayed to a user, during the step 116, server 202 serves the message tailored during the step 114 for display on the Web page served during the step 110. For purposes of the method 100 and other methods disclosed herein, the step 116 will be considered satisfied and implemented if the Web page served during the step 110 includes an ad tag or other instruction included in it, perhaps as part of the Web page's HTML code, that causes a request for the message, or a rich media file that includes the message, to be sent from a device (e.g., a user device) that is displaying the Web page when the Web page is displayed or process by the device. The request may be sent to a device other than the device that served the Web page during the step 110. Thus, the step 116 may be completed by coding the Web page served during the step 110 such that the message is served or otherwise sent (perhaps as part of a rich media file) from a device other than the server 202 or other than the device that served the Web page during the step 110. As a result, “serving the message” includes, and is completed by, directing a recipient device of the Web page served during the step 110 to where the recipient device can send a request for a rich media file containing the message. The rich media file containing the message may also include the advertisement served during the step 112. In addition, the rich media file may include code that determines how a message is to be tailored or displayed. Directing of the recipient device can be completed by including an ad tag or appropriate instruction in the HTML code for the Web page served during the step 110.

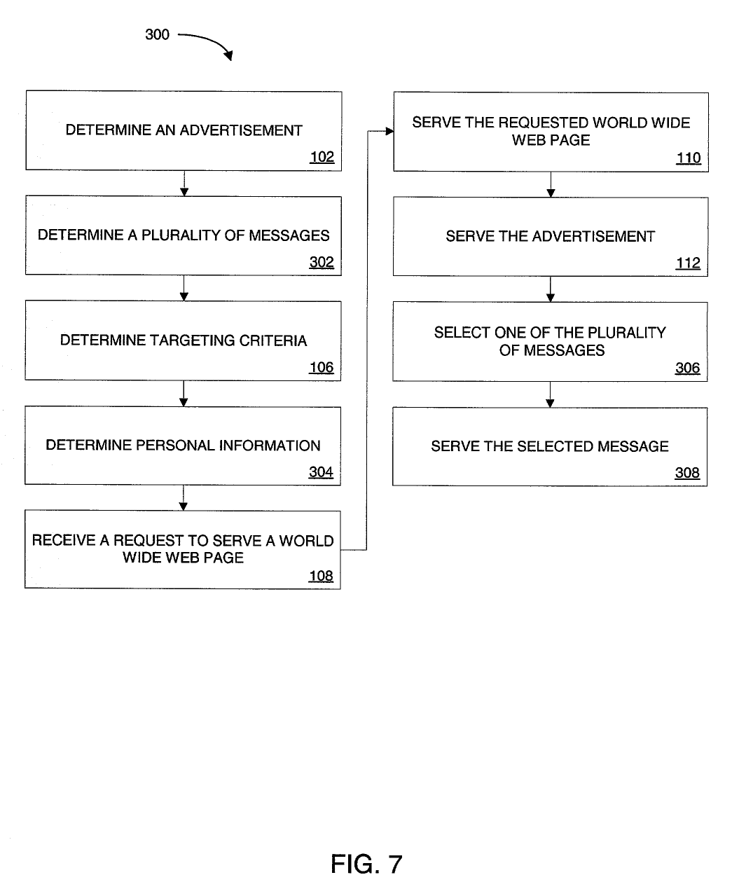

Now referring to FIG. 7, a second embodiment 300 of a method in accordance with the present invention is illustrated. The method 300 includes the steps 102, 106, 108, 110 and 112 previously described above. In addition, the method 300 includes a step 302 during which multiple messages are determined.

The step 302 is similar to the step 104 previously described above except that in the step 302 at least two messages are determined. The step 104 in the method 100 only requires that at least one message be determined. In some embodiments, multiple messages may be associated with the advertisement determined during the step 102. For example, a single advertisement may have different messages displayed along with it for a user depending on the age of the user, the gender of the user, the income of the user, etc. Alternatively, the advertisement determined during the step 102 may have a first message displayed with it if no information is know or available regarding a user to whom the advertisement is displayed and a second message displayed with it if information needed to personal the second message for a specific user is known or available. Thus, the first message may be used as a default message in cases where the second message cannot be used. For example, if the advertisement is directed to a restaurant, the second message may state “Hey Samantha, Join us for a Great Steak” while the default message may state more generically: “Here is a Great Place to Get a Great Meal”.

During the step 106, targeting criteria is determined in a manner similar to that described above. Since the targeting criteria may be determine when to use one or more of the messages determined during the step 302 and/or how the messages are to be personalized, in some embodiments of the method 300 the step 302 may not be needed or it may be completed as part of the step 102.

During a step 304, personal information is retrieved or received for use in determining if the targeting criteria determined during the step 106 has been met and/or for use in determining which of the messages determined during the step 302 to display to a specific user. For example, during the step 304, the server 202 may determine if a specific user is male or female. If the user is male, the server 202 may use a different message than if the user is female. One or both of the messages may be tailored so as to include the user's name.

The steps 108, 110 and 112 are completed as previously described above. In some embodiments of the method 300, one or more of the steps 108, 110 and 112 may be completed before the step 304. For example, the server 202 may receive a request from a user via a user device to serve a specific Web page during the step 108 for display on the user device. During the step 304 completed after the step 108, the server 202 may ascertain if the user is male or female. If the advertisement is part of a rich media file that also contains the message and code governing how the message is to be tailored, the step 304 may need to be performed after the step 110 and even the step 112 so as to make sure what personal information is needed for the message.

During a step 306, the server 202 selects one of the messages determined during the step 302. The selection may be based in whole or in part on the targeting criteria determined during the step 106 and/or the personal information determined during the step 304. For example, the targeting criteria determined during the step 106 may provide that a first message is to be displayed to a user only if the user is male and under thirty years of age, that a second message is to be displayed to the user only if the user is male and over thirty years of age, that a third message is to be displayed to the user if the user is female, and that a fourth default message is to be used when a determination cannot be made regarding the sex or age of the user. In some embodiments of the method 300, the message selected during the step 306 may be tailored in a manner similar to that described above for the step 114.

During the step 308, the server 202 serves the message selected during the step 306 in a manner similar to that of the step 116 previously described above. As previously discussed above in regards to the step 116, the step 308 maybe considered complete if the Web page served during the step 110 includes an ad tag or other instruction telling a device receiving the Web page where to request the message, or rich media file containing the message. A single request for the rich media file may cause both the advertisement to be served during the step 112 and the message to be served during the step 308. The single request for the rich media file may be initiated by browser software operating on a user device that receives the Web page served during the step 110.

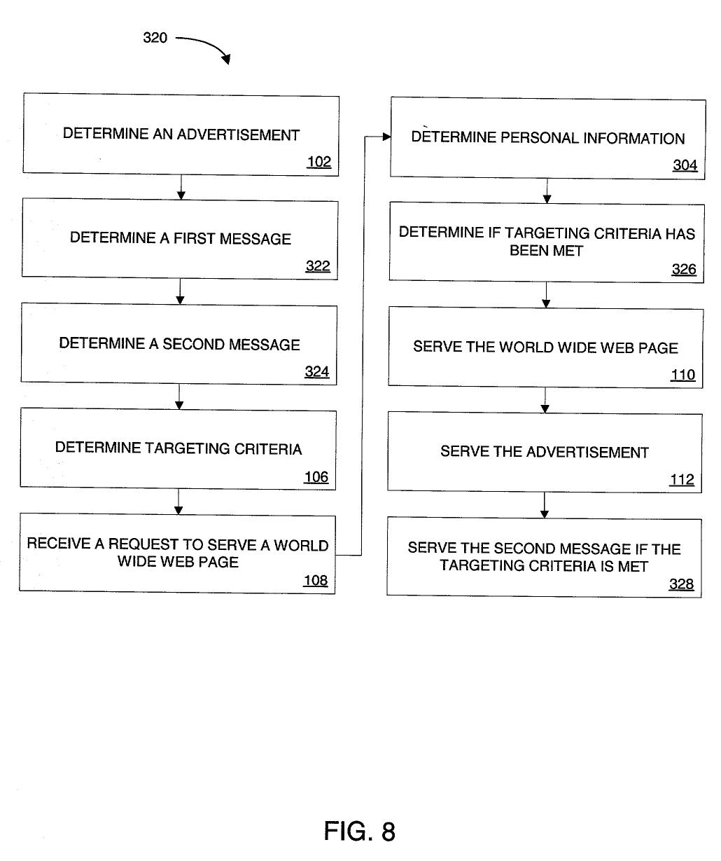

Now referring to FIG. 8, a third embodiment 320 of a method in accordance with the present invention is illustrated. The method 320 includes the steps 102,106, 108, 110 and 112 previously described above. In addition, the method 320 includes a step 322 during which a first message is determined in a manner similar to that of the step 104 previously described above. The method 320 includes a step 324 during which a second message is determined in a manner similar to that of the step 104 previously described above. The steps 322 and 324 may be completed in opposite order or combined into a single step.

The steps 106, 108 and 304 are performed during the method 320 in a manner similar to that described above. The steps 106 and/or 108 may be completed before or after any one or more of the steps 102, 322 and 324. In addition, the step 304 may occur before any of the steps 102, 322 and/or 324, although the step 304 will usually occur after the step 108 since the personal information determined during the step 304 will be for a user sending the request received during the step 108.

During a step 326, the server 202 may determine if the targeting criteria determined during the step 106 has been met for the second message. For example, the targeting criteria determined during the step 106 may require a user to have an income over fifty-thousand dollars a year in order to receive the second message determined during the step 324. As another example, the targeting criteria determined during the step 106 may require a user to live in the New York City metropolitan area in order to receive the second message determined during the step 324.

The steps 110 and 112 are performed during the method 320 in a manner similar to that described above. Either or both of the steps 110 and 112 may be completed or initiated prior to the step 326.

During a step 328, the server 202 serves the second message determined during the step 324 if the targeting criteria determined during the step 106 is satisfied. If the targeting criteria is not 5 satisfied, the second message is not served during the step 328. In some embodiments of the method 300, the first message determined during the step 322 maybe served instead of the second message if the targeting criteria is not met. In other embodiments of the method 300, neither the first nor the second message will be served if the targeting criteria is not met. The step 328 is similar to the steps 116 and 308 previously discussed above and may be considered to be completed by proper coding of the Web page served during the step 110.

In some embodiments of the method 300, the second message served during the step 329 may be tailored in a manner similar to that described above for the step 114.

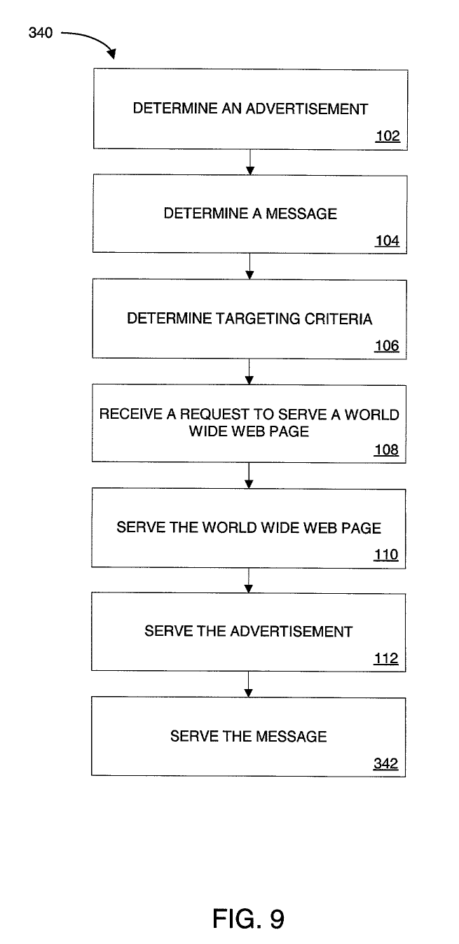

Now referring to FIG. 9, a fourth embodiment 340 of a method in accordance with the present invention is illustrated. The method 340 includes the steps 102, 104, 106, 108, 110, and 112 previously described above. In contrast to the method 100, however, the method 340 does not include either of the steps 114 and 116. Instead, the method 340 includes a step 342 during which the message determined during the step 104 is served without prior tailoring of the message. The step 342 is similar to the steps 116 and 308 previously discussed above and may be considered to be completed by proper coding of the Web page served during the step 110.

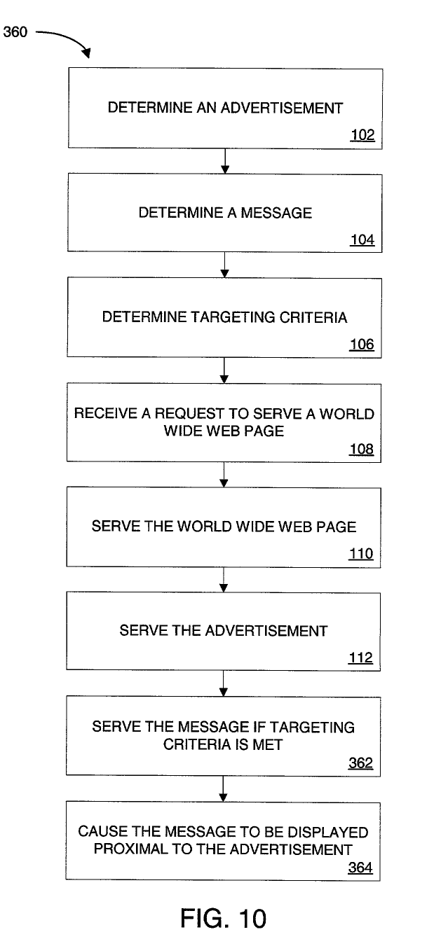

Now referring to FIG. 10, a fifth embodiment 360 of a method in accordance with the present invention is illustrated. The method 360 includes the steps 12, 104, 106, 108, 110, and 112 previously described above. In addition, the method 360 includes a step 362 during which the message determined during the step 104 is served only if the targeting criteria determined during the step 106 is satisfied. The step 362 is similar to the step 328 previously described above. During a step 364, the message is displayed such that it is positioned or displayed close to or other proximal to advertisement served during the step 112. Positioning of the message may occur by proper HTML coding of the Web page served during the step 110 or by sending special instructions along with the message when the message is served during the step 362.

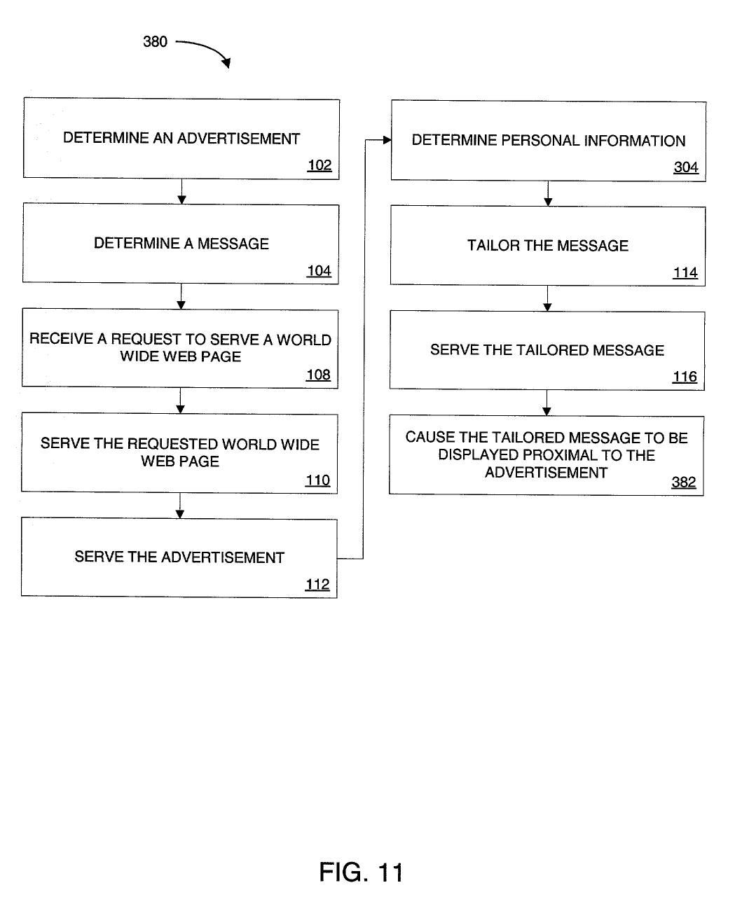

Now referring to FIG. 11, a sixth embodiment 380 of a method in accordance with the present invention is illustrated. The method 380 includes the steps 12, 104, 108, 110, 112, 114, 116, and 304 previously described above. In addition, the method 380 includes a step 382 during which the tailored message served during the step 116 is positioned close to or proximal to the advertisement served during the step 112. The step 382 is similar to the step 364 previously described above. Note that the method 380 does not use targeting criteria. Thus, the message determined during the step 104 is served for display on a Web page every time the advertisement determined during the step 102 is served for display on the Web page. The step 382 can be completed as part of the step 116.

Other possible implementations of the method of the present invention are also possible. For example, another embodiment similar to the method 380 would omit the steps 304 and 114 and substitute steps for the steps 116 and 382 such that tailored messages are not used. The message determined during the step 104 preferably would be served such that it is displayed proximal to the advertisement served during the step 112. Each of the methods described herein may be implemented by a single server or a group of servers or devices operated by or for a single entity.

In embodiments of the methods disclosed above, a message displayed on a Web page maybe thematically related to an advertisement displayed on the Web page. That is, the subject matter of the message may be related to the subject matter of the advertisement. For example, if an advertisement served for display on a Web page is directed to a car rental agency, the message might state “Check Out These Great Deals on Rental Cars!”. As another example, if the advertisement is directed to laundry detergent, the message might state “Nothing Gets Your Clothes as Clean as This!”. Of course, the message can also be personalized or otherwise tailored. For example, the message above might be personalized to state “Hey Samantha, Check Out These Great Deals on Rental Cars!” for a user named Samantha and an advertisement directed to a car rental agency. Thematically relating the message to the advertisement helps direct attention to the advertisement and increases user response rates to the advertisements. Personalizing or otherwise tailoring the message can create an even greater impact.

In some embodiments, a message might not be displayed on a Web page until after a fixed or predetermined period of time after an advertisement is displayed on the Web page. Alternatively, the message may be display only for a fixed or predetermined period of time on the Web page. The advertisement may remain on the Web page even after the message disappears. Once a message is removed from the Web page, a second or follow-up message may be displayed. Thus, a series of messages might be displayed in conjunction with a single advertisement on a Web page.

While the targeting criteria discussed above is described as being used to target and manage messages, it should be noted that the targeting criteria may also be used to select and target advertisements. Thus, in cases where a message is to be displayed to a user only if the user is male, the targeting criteria may be used to display an advertisement associated with the message only if the user is male.

As described above, a rich media file may be used, the rich media file including an advertisement to be displayed on a page and a tailorable message to be displayed on the Web page, wherein the rich media filed is callable by an ad tag associated with the Web page or included in the coding for the Web page. The ad tag maybe viewable as part of the HTML source for the Web page. When the Web page is displayed on a user device via browser software, the browser will make a call to retrieve the rich media file based on the ad tag. The rich media file may be stored on the server 202 or on some other device. The rich media file may also include code (e.g., JAVA script) that controls how the message is to be tailored. For example, the code may instruct the browser or the server 202 to retrieve information stored in a cookie on the user device to obtain personal information (e.g., first name, credit card number, number of frequent flyer miles, number of sweepstakes entries) about the person using the user device. The message also may be thematically related to the advertisement.

Also as described above, a Web page maybe generated by HTML code, wherein the HTML code includes an ad tag that causes or otherwise initiates a call for a rich media file when the Web page is displayed on a user device. The rich media file may include an advertisement to be displayed on the Web page and a tailorable message to be displayed on the Web page. The rich media file may also include code (e.g., JAVA script) that governs how the message is to be tailored. In some embodiments, the message may be thematically related to the advertisement.

The present invention also includes a method for displaying an advertisement in conjunction with a message by serving a Web page, the Web page being HTML encoded and including an ad tag that initiates a call for a rich media file when the Web page is displayed on a user device. The call may be completed or initiated by browser software operating on the user device. As described above, the rich media file may include the advertisement to be displayed on the Web page and the tailorable message to be displayed on the Web page. The rich media file may also include code (e.g., JAVA script) that controls how the message is to be tailored when the message is displayed on the Web page. In some embodiments, the message may be thematically related to the advertisement.

The present invention also includes a method for displaying an advertisement in conjunction with a message by determining an advertisement, determining a message associated with the advertisement, and including both the advertisement and the message in a rich media file as previously described above. Thus, a method for displaying an advertisement and a message on a Web page can include determining an advertisement to be displayed on a Web page in a manner similar to the step 102 described above, determining a tailorable message to be displayed on the Web page in a manner similar to the step 104 described above, preparing a rich media file that contains the advertisement, the message, and code governing how the message is to be tailored when the message is displayed on said Web page, and serving the Web page in response to a request received for Web page. The message may be thematically related to the advertisement and/or positioned proximal to the advertisement on the Web page when the Web page is displayed.

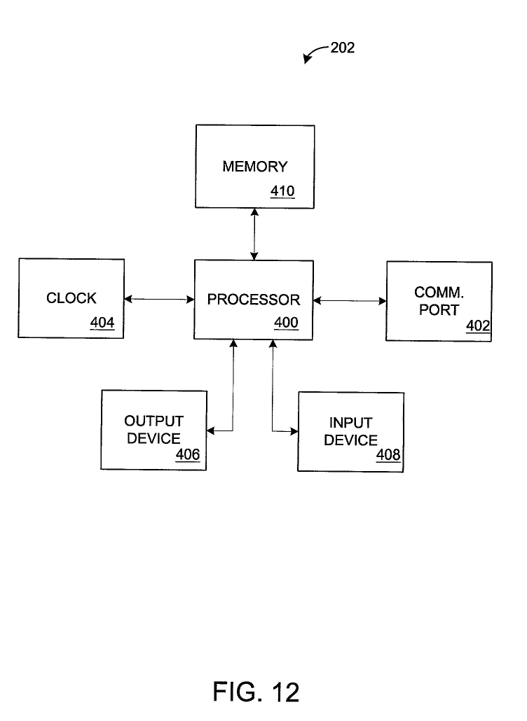

Now referring to FIG. 12, a representative block diagram of a Web site server, such as the server 202, is illustrated. The server 202 may include a processor, microchip, central processing unit, or computer 400 that is in communication with or otherwise uses or includes one or more communication ports 402 for communicating with user devices and/or other devices. Communication ports may include such things as local area network adapters, wireless communication devices, etc. The server 202 may also include an internal clock element 404 to maintain an accurate time and date for the server 202, create time stamps for search results received by or at the server 202, etc.

If desired, the server 202 may include one or more output devices 406 such as a printer, infrared or other transmitter, antenna, audio speaker, display screen or monitor, text to speech converter, etc., as well as one or more input devices 408 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 202 may include a memory or data storage device 410 to store information, software, databases, search terms, device drivers, Web pages, advertisements, user information, messages, rich media files, navigation path options, etc. The memory or data storage device 410 preferably comprises an appropriate combination of magnetic, optical and/or semiconductor memory, and may include, for example, Random Access Memory (RAM), Read-Only Memory (ROM), a tape drive, flash memory, a floppy disk drive, a ZIP™ disk drive, a compact disc and/or a hard disk.

The processor 400 and the data storage device 410 in the server 202 may each be, for example: (i) located entirely within a single computer or other computing device; or (ii) connected to each other by a remote communication medium, such as a serial port cable, telephone line or radio frequency transceiver. In one embodiment, the server 202 may comprise one or more computers that are connected to a remote server computer for maintaining databases.

A conventional personal computer or workstation with sufficient memory and processing capability may be used as the server 202. In one embodiment, the server 202 operates as or includes a Web server for an Internet environment. The server 202 preferably is capable of high volume transaction processing, performing a significant number of mathematical calculations in processing communications and database searches. A Pentium™ microprocessor such as the Pentium III™ microprocessor, manufactured by Intel Corporation may be used for the processor 400. Equivalent processors are available from Motorola, Inc., AMD, or Sun Microsystems, Inc. The processor 400 may also comprise one or more microprocessors, computers, computer systems, etc.

Software may be resident and operating or operational on the server 202. The software may be stored on the data storage device 410 and may include a control program for operating the server, databases, etc. The control program may control the processor 400. The processor 400 preferably performs instructions of the control program, and thereby operates in accordance with the present invention, and particularly in accordance with the methods described in detail herein. The control program maybe stored in a compressed, uncompiled and/or encrypted format. The control program furthermore includes program elements that may be necessary, such as an operating system, a database management system and device drivers for allowing the processor 400 to interface with peripheral devices, databases, etc. Appropriate program elements are known to those skilled in the art, and need not be described in detail herein. According to an embodiment of the present invention, the instructions of the control program may be read into a main memory from another computer-readable medium, such as from a ROM to RAM. Execution of sequences of the instructions in the control program causes the processor 400 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

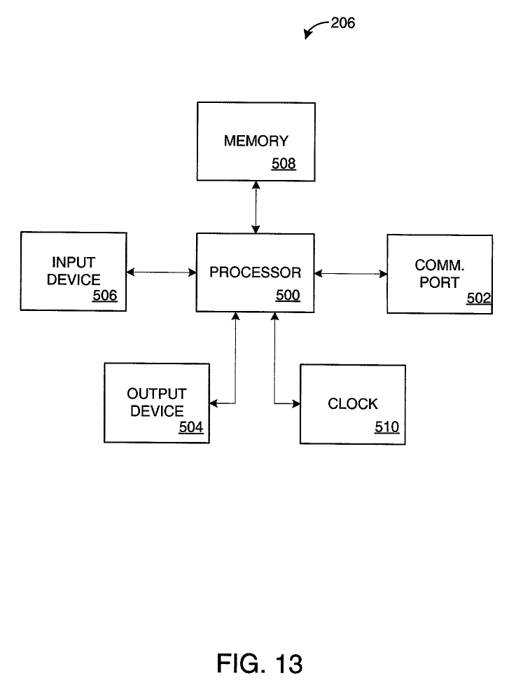

Now referring to FIG. 13, a representative block diagram of a user device, such as the user device 206, is illustrated. The user device 206 may include a processor, microchip, or computer 500 that is in communication with or otherwise uses or includes one or more communication ports 502 for communicating with Web site servers, database servers, etc. For example, the user device 206 may have an infrared or other transmitter as one communication port to allow the user device 206 to communicate with the server 202. In addition, if the user device 206 is connected to the server 202 via an Ethernet local area network, the user device 206 may include an Ethernet adapter as a communication port to allow the user device 206 to communicate with the server 202.

The user device 206 may include one or more output devices 504 for conveying information, such as a printer, audio speaker, infrared or other transmitter, antenna, display screen or monitor, text to speech converter, etc. The user device 206 may also include one or more input devices 506 for receiving information, such as a bar code reader or other optical scanner, infrared or other receiver, antenna, magnetic stripe reader, image scanner, roller ball, touch pad, joystick, touch screen, microphone, computer keyboard, computer mouse, etc. The user device 206 may also include a fingerprint scanner or reader, a retinal scanner, a voice analyzer, or other biometrics data input device as an input device 506 to allow the user device 206 to identify users of the user device 206.

In addition to the above, the user device 206 may include a memory or data storage device 508 to store information, software, databases, device drivers, user information, search terms, Web pages, cookies, messages, user information, browsers, computer software, operating systems, advertisements, etc. The memory or data storage device 508 preferably comprises an appropriate combination of magnetic, optical and/or semiconductor memory, and may include, for example, Random Access Memory (RAM), Read-Only Memory (ROM), a tape drive, flash memory, a floppy disk drive, a Zip™ disk drive, a CD-ROM drive, and/or a hard disk.

The user device 206 may also include an internal clock element 510 to maintain an accurate time and date for the user device 206, create time stamps for information, search requests, Web page requests, Web pages, messages, cookies, advertisements, etc. generated or received via the user device 206.

As previously discussed above, possible user devices include a personal computer, portable computer, mobile or fixed user station, workstation, network terminal or server, telephone, beeper, kiosk, dumb terminal, personal digital assistant, facsimile machine, etc. If desired, the user device 206 may also function as the server 202.

The foregoing description is considered as illustrative only of the principles of the invention. Furthermore, since numerous modifications and changes will readily occur to those skilled in the art, it is not desired to limit the invention to the exact construction and process shown and described above. Accordingly, all suitable modifications and equivalents may be resorted to falling within the scope of the invention as defined by the claims which follow. Further, even though only certain embodiments have been described in detail, those having ordinary skill in the art will certainly understand that many modifications are possible without departing from the teachings thereof. All such modifications are intended to be encompassed within the following claims.

The present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein can be implemented in many different ways using a wide range of programming techniques as well as general purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

While specific implementations and hardware configurations for Web site servers and user devices have been illustrated, it should be noted that other implementations and hardware configurations are possible and that no specific implementation or hardware configuration is needed. Therefore, many different types of implementations or hardware configurations can be used in the system 200 and the methods disclosed herein are not limited to any specific hardware configuration. An ad server may have a configuration similar to the server 202 and/or the user device.

Each of the methods described above can be performed on a single computer, computer system, microprocessor, etc. In addition, two or more of the steps in each of the methods described above could be performed on two or more different computers, computer systems, microprocessors, etc., some or all of which maybe locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The terms “computer-readable medium,” “computer program,” “computer software,” “software” and “program” as used herein includes to any medium that directly or indirectly participates in providing instructions to a processor for execution. Such a medium may take many forms, including but not limited to, non-volatile media, volatile media, and transmission media. Non-volatile media include, for example, optical or magnetic disks. Volatile media include dynamic random access memory (DRAM), which typically constitutes the main memory. Transmission media include coaxial cables, copper wire and fiber optics, including the wires that comprise a system bus coupled to a processor. Transmission media can also take the form of acoustic, electrical or electromagnetic waves, such as those generated during radio frequency (RF) and infrared (IR) data communications.

The connections or communications between user devices, Web site servers, and database servers discussed herein is only meant to be generally representative of cable, computer, telephone, or other communication or data networks and methods for purposes of elaboration and explanation of the present. The connections are also intended to be representative of, and include all or a part of, the Internet, the World Wide Web, and other privately or publicly operated networks, including wide area networks, local area networks, data communication networks or connections, intranets, routers, satellite links or networks, microwave links or networks, cellular telephone or radio links, fiber optic transmission lines, ISDN lines, T1 lines, etc. In addition, as used herein, the terms “computer,” “user device,” “terminal,” “client,” “device” and “client device” are generally interchangeable and are meant to be construed broadly and to include, but not be limited to, all clients, client devices or machines, personal digital assistants and palm top computers, cash registers, terminals, computers, point-of-sale devices, processors, servers, etc. connected or connectable to a computer or data communications network and all devices on which internet-enabled software, such as the NETSCAPE COMMUNICATOR™ or NAVIGATOR™ browsers, MOSAIC™ browser, or MICROSOFT INTERNET EXPLORER™ browsers, can operate or be run. The term “browser” should also be interpreted as including Internet-enabled software and computer or client software that enables or allows communication over a computer network and Internet-enabled or World Wide Web enabled, monitored, or controlled devices such as WebTV™ devices, household appliances, phones, etc.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof. Also, as used in this specification and the claims that follow, the term “Web page” shall be construed so as to include such things as windows, splash pages, jump pages, interstitials, superstitials, pop-up windows, home pages, HTML encoded pages, etc. that may be displayed on a user or other client device, typically by browser software operating on the user or other client device.

The embodiments of the invention in which an exclusive property or privilege is claimed are defined as follows:

1. A method for displaying a message in conjunction with an advertisement on a World Wide Web page, comprising:
determining an advertisement to be displayed on a World Wide Web page;
determining a message to be displayed on said World Wide Web page, wherein said message is thematically related to said advertisement;
determining targeting criteria associated with said message;
receiving a request to serve said World Wide Web page;
serving said World Wide Web page;
serving said advertisement for display on said World Wide Web page;
tailoring said message page based, at least in part, on said targeting criteria; and
serving said tailored message for display on said World Wide Web page

2. The method of claim 1, further comprising:
storing personal information.

3. The method of claim 2, wherein said tailoring said message is based, at least in part, on said personal information.

4. The method of claim 1, further comprising:
receiving personal information.

5. The method of claim 4, wherein said tailoring said message is based, at least in part, on said personal information.

6. The method of claim 1, further comprising:
determining if said targeting information has been met.

7. The method of claim 1, wherein said serving said advertisement includes directing a request to serve said advertisement to an ad server.

8. The method of claim 1, further comprising:
determining personal information prior to said serving said tailored message.

9. The method of claim 8, wherein said determining personal information includes retrieving a cookie containing personal information from a user device.

10. The method of claim 8, further comprising storing said personal information in a database and wherein-said determining personal information includes retrieving said personal information from said database.

11. The method of claim 1, further comprising:
setting a first time period.

12. The method of claim 11, wherein said serving said tailored message occurs at least said first time period after said serving said World Wide Web page.

13. The method of claim 11, wherein said serving said tailored message occurs at least said first time period after said serving said advertisement.

14. The method of claim 1, wherein said serving said messages includes causing said tailored message to be displayed on said World Wide Web page for at least a fixed period of time.

15. The method of claim 14, further comprising:
determining said fixed period of time.

16. The method of claim 1, wherein said serving said tailored messages includes causing said tailored message to be displayed on said World Wide Web page for a fixed period of time.

17. The method of claim 1, further comprising:
causing said tailored message to no longer be displayed on said World Wide Web page; and
serving a second message.

18. The method of claim 1, further comprising:
determining if said targeting criteria has been met prior to said serving said tailored message.

19. The method of claim 1, further comprising:
determining if said targeting criteria has been met prior to said serving said advertisement.

20. The method of claim 1, wherein said targeting criteria is based on at least one of the following:
gender information;
age information;
educational background information;
income information;
date of birth information;
purchasing history information;
occupation information;
financial account information;
credit card limit information;
family information;
navigational history information;
user activity on said World Wide Web page;
residence information; and
preference information.

21. The method of claim 1, further comprising:
determining external information.

22. The method of claim 21, wherein said tailoring said message is based, at least in part, on said external information.

23. The method of claim 21, wherein said external information includes at least one of the following:
date information; and
time information.

24. The method of claim 1, wherein said World Wide Web page is arranged such that said advertisement is displayed proximal to said tailored message.

25. The method of claim 1, wherein said World Wide Web page is arranged such that said tailored message is displayed within said advertisement.

26. The method of claim 1, further comprising:
changing a display attribute of at least a portion of said tailored message.

27. The method of claim 26, wherein said display attribute is one of the following:
font;
size;
color;
boldness; and
blink rate.

28. The method of claim 26, wherein said changing a display attribute includes causing at least a portion of said tailored message to blink.

29. The method of claim 1, further comprising:
associating code with said advertisement such that said serving said tailored message occurs automatically when said advertisement is served.

30. The method of claim 1, wherein said message and said advertisement are part of a rich media file.

31. A method for displaying a message in conjunction with an advertisement on a World Wide Web page, comprising:
determining an advertisement to be displayed on a World Wide Web page;
determining a plurality of messages associated with said advertisement wherein each of said plurality of messages is thematically related to said advertisement;
determining targeting criteria associated with said plurality of messages;
determining personal information;
receiving a request to serve said World Wide Web page;
serving said World Wide Web page;
serving said advertisement for display on said World Wide Web page;
selecting at least one of said plurality of messages based, at least in part, on said personal information and said targeting criteria; and
serving said at least one of said plurality of messages for display on said World Wide Web page.

32. The method of claim 31, further comprising;
determining personal information.

33. The method of claim 31, further comprising:
tailoring said at least one of said plurality of messages based, at least in part, on said personal information prior to serving said at least one of said plurality of messages.

34. The method of claim 33, further comprising:
storing said personal information prior to said determining personal information.

35. The method of claim 31, further comprising: tailoring said at least one of said plurality of messages prior to serving said at least one of said plurality of messages.

36. The method of claim 31, wherein said serving said advertisement includes directing a request to serve said advertisement to an ad server.

37. The method of claim 31, wherein said World Wide Web page is designed such that said advertisement is displayed proximal to said at least one of said plurality of messages.

38. A method for displaying a message in conjunction with an advertisement on a World Wide Web page, comprising:
determining an advertisement to be displayed on a World Wide Web page;
determining a first message associated with said advertisement;
determining a second message associated with said advertisement, wherein said second message is related to said advertisement's subject matter;
determining targeting criteria associated with said second message;
receiving a request to serve said World Wide Web page;
determining personal information;
determining if said targeting criteria has been met based, at least in part, on said personal information;
serving said World Wide Web page;
serving said advertisement for display on said World Wide Web page; and
serving said second message for display on World Wide Web page if said targeting criteria has been met.

39. The message of claim 38, further comprising:
serving said first message if said targeting criteria has not been met.

40. The method of claim 38, further comprising:
tailoring said second message based, at least in part, on said personal information, if said targeting criteria has been met

41. The method of claim 38, wherein said World Wide Web page is designed such that said advertisement is displayed proximal to said second message.

42. The method of claim 38, wherein said first message's subject matter is related to said advertisement's subject matter.

43. The method of claim 38, wherein said second message is associated with said advertisement by code that is run as a result of said advertisement being served.

44. The method of claim 38, wherein said second message and said advertisement are included in a rich media file.

45. A method for displaying a message in conjunction with an advertisement on a World Wide Web page, comprising:
determining an advertisement to be displayed on a World Wide Web page;
determining a message to be displayed on said World Wide Web page, wherein said message's subject matter is related to said advertisement's subject matter;
determining targeting criteria associated with said message;
receiving a request to serve said World Wide Web page;
serving said World Wide Web page;
serving said advertisement for display on said World Wide Web page; and
serving said message for display on said World Wide Web page if said targeting criteria has been met.

46. The method of claim 45, further comprising:
serving a default message if said targeting criteria has not been met.

47. The method of claim 46, further comprising:
determining said default message.

48. The method of claim 45, further comprising:
determining if said targeting criteria has been met.

49. The method of claim 48, further comprising:
determining personal information.

50. The method of claim 45, further comprising:
tailoring said message based, at least in part, on said personal information, if said targeting criteria has been met

51. The method of claim 45, wherein said World Wide Web page is designed such that said advertisement is displayed proximal to said message.

52. The method of claim 45, wherein said message is associated with said advertisement such that said message is retrieved when said advertisement is served.

53. The method of claim 45, wherein said message is associated with said advertisement such that serving said advertisement causes said message to be served.

54. A method for displaying a message in conjunction with an advertisement on a World Wide Web page, comprising:
determining an advertisement to be displayed on a World Wide Web page;
determining a message to be displayed on said World Wide Web page, said message being associated with said advertisement;
determining targeting criteria associated with said message;
receiving a request to serve said World Wide Web page;
serving said World Wide Web page;
serving said advertisement for display on said World Wide Web page;
serving said message for display on said World Wide Web page if said targeting criteria has been met; and
causing said message to be displayed proximal to said advertisement on said World Wide Web page if said targeting criteria has been met.

55. The method of claim 54, wherein said message is thematically related to said advertisement.

56. A method for displaying a message in conjunction with an advertisement on a World Wide Web page, comprising:
determining an advertisement to be displayed on a World Wide Web page;
determining a message to be displayed on said World Wide Web page, wherein said message is associated with said advertisement;
receiving a request to serve said World Wide Web page;
serving said World Wide Web page;
serving said advertisement for display on said World Wide Web page;
determining personal information;
tailoring said message page based, at least in part, on said personal information;
serving said tailored message for display on said World Wide Web page; and
causing said tailored message to be displayed proximal to said advertisement on said World Wide Web page.

57. The method of claim 56, wherein said message is thematically related to said advertisement.

58. A method for displaying a message in conjunction with an advertisement on a World Wide Web page, wherein the advertisement and the World Wide Web page have been served, comprising:
determining targeting criteria associated with the advertisement;
determining personal information;
tailoring a message based on said personal information and said targeting criteria; and
serving said tailored message for display on the World Wide Web page.

59. The method of claim 58, further comprising:
causing said message to be displayed in proximity to said advertisement on said World Wide Web page.

60. The method of claim 58, wherein said tailored message is thematically related to the advertisement.

61. A computer readable medium, the computer readable medium comprising a rich media file that includes an advertisement to be displayed on a World Wide Web page and a tailorable message to be displayed on said World Wide Web page, wherein said rich media file is callable via an ad tag associated with said World Wide Web page.

62. The computer readable medium of claim 61, wherein said rich media file includes code controlling how said message is to be tailored.

63. A portion of computer software, comprising a rich media file that includes an advertisement to be displayed on a World Wide Web page, a tailorable message to be displayed on said World Wide Web page, and code for controlling how said message is be tailored, wherein said rich media filed is callable via an ad tag associated with HTML code for said World Wide Web page.

64. A computer readable medium, the computer readable medium comprising code for a World Wide Web page, wherein said code includes an ad tag that causes a call for a rich media file when said World Wide Web page is displayed on a user device, the rich media file including an advertisement to be displayed on said World Wide Web page and a tailorable message to be displayed on said World Wide Web page.

65. The computer readable medium of claim 64, wherein said rich media file includes code controlling how said message is to be tailored.

66. A portion of computer software, comprising code for a World Wide Web page, wherein said code includes an ad tag that causes a call for a rich media file when said World Wide Web page is displayed on a user device, the rich media file including an advertisement to be displayed on said World Wide Web page, a tailorable message to be displayed on said World Wide Web page, and code controlling how said message is to be tailored.

67. A method for displaying an advertisement and a message on a World Wide Web page, comprising:
determining an advertisement to be displayed on a World Wide Web page;
determining a tailorable message to be displayed on said World Wide Web page;
preparing a rich media file that contains said advertisement, said message, and code governing how said message is to be tailored when said message is displayed on said World Wide Web page, wherein said World Wide Web page includes an ad tag directed to said rich media file; and
serving said World Wide Web page in response to a request for said World Wide Web page.

68. The method of claim 67, wherein said message is thematically related to said advertisement.

69. The method of claim 67, wherein said World Wide Web page is arranged such that said advertisement is positioned proximal to said message when said advertisement and said message are displayed on said World Wide Web page.

70. The method of claim, further comprising:
providing information necessary to tailor said message.

71. The method of claim 70, further comprising:
retrieving said information.

72. A system for serving an advertisement, comprising:
a memory;
a communication port; and
a processor connected to said memory and said communication port, said processor being operative to:
determine an advertisement to be displayed on a World Wide Web page;
determine a message to be displayed on said World Wide Web page, wherein said message is associated with said advertisement;
receive a request to serve said World Wide Web page;
serve said World Wide Web page;
serve said advertisement for display on said World Wide Web page;
determine personal information;
tailor said message page based, at least in part, on said personal information; and
serve said tailored message for display on said World Wide Web page.

73. A computer readable medium for use in a server hosting a World Wide Web site, the computer readable medium storing a computer program comprising:
computer readable means for establishing an advertisement to be displayed on a World Wide Web page;
computer readable means for establishing a message to be displayed on said World Wide Web page, wherein said message is associated with said advertisement;
computer readable means for obtaining a request to serve said World Wide Web page;
computer readable means for transmitting said World Wide Web page;
computer readable means for transmitting said advertisement for display on said World Wide Web page;
computer readable means for retrieving personal information;
computer readable means for customizing said message page based, at least in part, on said personal information; and
computer readable means for transmitting said customized message for display on said World Wide Web page.

74. An apparatus for serving an advertisement, comprising:
means for establishing an advertisement to be displayed on a World Wide Web page;
means for establishing a message to be displayed on said World Wide Web page, wherein said message is associated with said advertisement;
means for obtaining a request to serve said World Wide Web page;
means for transmitting said World Wide Web page;
means for transmitting said advertisement for display on said World Wide Web page;
means for retrieving personal information;
means for customizing said message page based, at least in part, on said personal information; and
means for transmitting said customized message for display on said World Wide Web page.

75. A system for displaying an advertisement and a message on a World Wide Web page, comprising:
a memory;
a communication port; and
a processor connected to said memory and said communication port, said processor being operative to:
determine an advertisement to be displayed on a World Wide Web page;
determine a tailorable message to be displayed on said World Wide Web page;
prepare a rich media file that contains said advertisement, said message, and code governing how said message is to be tailored when said message is displayed on said World Wide Web page, wherein said World Wide Web page includes an ad tag directed to said rich media file; and
serve said World Wide Web page in response to a request for said World Wide Web page.

76. A computer readable medium for use in a server hosting a World Wide Web site, the computer readable medium storing a computer program comprising:
computer readable means for establishing an advertisement to be displayed on a World Wide Web page;
computer readable means for establishing a tailorable message to be displayed on said World Wide Web page;
computer readable means for creating a rich media file that contains said advertisement, said message, and code governing how said message is to be tailored when said message is displayed on said World Wide Web page, wherein said World Wide Web page includes an ad tag directed to said rich media file; and
computer readable means for transmitting said World Wide Web page in response to a request for said World Wide Web page.

77. An apparatus for serving an advertisement and a message associated with the advertisement, comprising:
means for establishing an advertisement to be displayed on a World Wide Web page;
means for establishing a tailorable message to be displayed on said World Wide Web page;
means for creating a rich media file that contains said advertisement, said message, and code governing how said message is to be tailored when said message is displayed on said World Wide Web page, wherein said World Wide Web page includes an ad tag directed to said rich media file; and
means for transmitting said World Wide Web page in response to a request for said World Wide Web page.
